(19) United States
(12) Patent Application Publication
(10) Pub. No.: US 2025/0371640 A1
(43) Pub. Date: Dec. 4, 2025

(54) VEHICLE PROCESSING APPARATUS

(71) Applicant: SUBARU CORPORATION, Tokyo (JP)

(72) Inventor: Harunobu HORIGUCHI, Tokyo (JP)

(21) Appl. No.: 19/185,637

(22) Filed: Apr. 22, 2025

(30) Foreign Application Priority Data
May 30, 2024 (JP) 2024-088228

(51) Int. Cl. G06Q 50/26

(52) U.S. Cl. CPC G06Q 50/265

(57) ABSTRACT

A vehicle processing apparatus configured to be applied to a vehicle includes one or more processors, and a non-transitory computer readable recording medium containing a program configured to be executed by the one or more processors. The program includes one or more commands. The one or more commands are configured to cause the one or more processors to: acquire current law information as road traffic-related law information; determine whether the current law information includes a revised provision provided by revision made to past law information, the past law information being held in a storage of the vehicle; and cause, when determining that the current law information includes the revised provision, an interface of the vehicle to present a notification that encourages handling in compliance with the revised provision.

### CROSS-REFERENCE TO RELATED APPLICATIONS

The present application claims priority from Japanese Patent Application No. 2024-088228 filed on May 30, 2024, the entire contents of which are hereby incorporated by reference.

### BACKGROUND

The disclosure relates to a vehicle processing apparatus that encourages compliance with a road traffic-related law.

Japanese Unexamined Patent Application Publication No. 2002-269681 discloses a technique that notifies a driver who drives a vehicle of a current regulation situation in accordance with update of traffic regulation information on a road on which the vehicle is to travel.

### SUMMARY

An aspect of the disclosure provides a vehicle processing apparatus configured to be applied to a vehicle. The vehicle processing apparatus includes one or more processors, and a non-transitory computer readable recording medium containing a program configured to be executed by the one or more processors. The program includes one or more commands. The one or more commands are configured to cause the one or more processors to: acquire current law information as road traffic-related law information; determine whether the current law information includes a revised provision provided by revision made to past law information, the past law information being held in a storage of the vehicle; and cause, when determining that the current law information includes the revised provision, an interface of the vehicle to present a notification that encourages handling in compliance with the revised provision.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating an exemplary schematic configuration of a vehicle according to one example embodiment of the disclosure.

FIG. 2 is a flowchart illustrating exemplary processing to be executed by a vehicle processing apparatus before a start of the vehicle illustrated in FIG. 1.

FIG. 3 is a flowchart illustrating exemplary processing to be executed by the vehicle processing apparatus after the start of the vehicle illustrated in FIG. 1.

### DETAILED DESCRIPTION

Although road traffic-related laws such as the road traffic act are revised in line with a trend of times, it is not easy for an occupant of a vehicle such as a driver to keep abreast of all revised provisions of the road traffic-related laws. Accordingly, some techniques have been desired that notify the occupant of the vehicle of contents corresponding to the revision or any other change made to the road traffic-related laws.

It is desirable to provide a technique that issues a notification indicating a revised content of a road traffic-related law at an appropriate timing.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

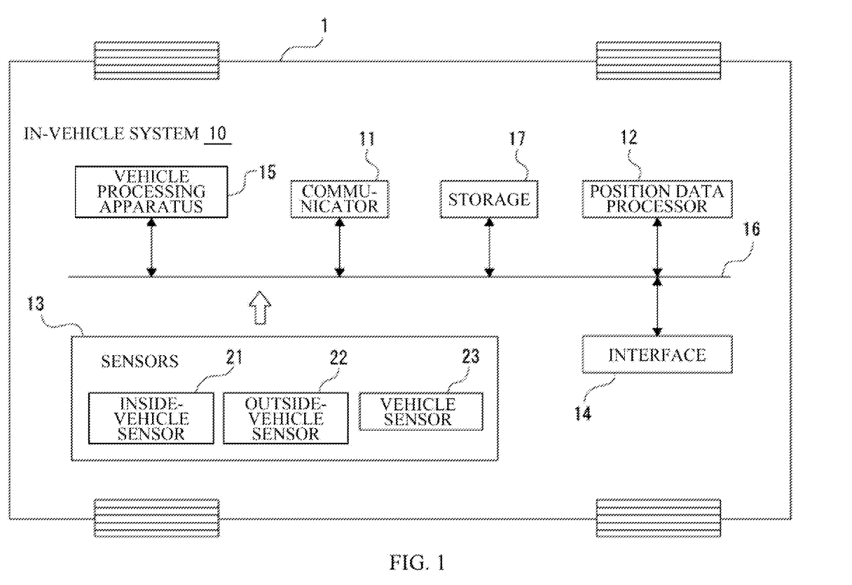

An example embodiment of the disclosure will now be described with reference to FIGS. 1 to 3. Note that the drawings referred to in the description each illustrate a part of components according to the example embodiment of the disclosure. Further, the components illustrated in the drawings may be modified in a variety of ways depending on design or other factors without departing from the scope of the technical idea of the disclosure. Furthermore, the disclosure is not limited to the example embodiment, and includes modifications and alterations insofar as they achieve the purpose of the disclosure.

The term "road traffic-related laws" (hereinafter, also referred to as a traffic law or traffic laws) used herein may refer to rules for a vehicle that are established by each country and with which a driver who drives the vehicle is to comply. In a case of Japan, the traffic laws may include rules such as the road traffic act, the regulations for enforcement of the road traffic act, or the order for the enforcement of the road traffic act. These traffic laws may be revised in content with changing times.

An exemplary configuration of a vehicle 1 according to the example embodiment will be described with reference to FIG. 1. Non-limiting examples of the vehicle 1 may include: an engine vehicle such as a gasoline-fueled vehicle; a hybrid vehicle such as a hybrid electric vehicle (HEV) including an engine and a motor; an electric vehicle driven by a motor alone; a fuel cell vehicle; and an engine vehicle using a synthetic fuel produced by synthesizing carbon dioxide and hydrogen.

The vehicle 1 may include an in-vehicle system 10. The in-vehicle system 10 may include a communicator 11, a storage 17, a position data processor 12, sensors 13, an interface 14, and a vehicle processing apparatus 15. The communicator 11, the storage 17, the position data processor 12, the interface 14, and the vehicle processing apparatus 15 may be coupled to each other via a bus 16.

The communicator 11 may wirelessly communicate with an external institution. The communicator 11 may communicate with a device such as a server of the external institution via a communication network such as the Internet. The external institution may be any entity such as an institution that manages traffic law-related information (hereinafter, also referred to as law information) (hereinafter, also referred to as a law management institution). The communicator 11 may acquire current law information NW through wireless communication from a device such as a server of the law management institution. The current law information NW may be related to the latest traffic law currently in force. In some embodiments, the communicator 11 may also acquire data such as data on a surrounding environment of a current position or data on a road of the current position via the communication network.

The storage 17 may hold law information such as the current law information NW or past law information OD. Every time when receiving the law information from the law management institution via the communicator 11, the storage 17 may be caused to hold the law information. In other words, at a time point when receiving the current law information NW via the communicator 11, the storage 17 may be in a state of holding the past law information OD.

The position data processor 12 may perform processing of identifying a position of the vehicle 1. The position data processor 12 may determine a current position of the vehicle 1 as longitude and latitude data acquired by a positioning system such as a global navigation satellite system (GNSS). The position data processor 12 may further determine an environment of the current position, i.e., a surrounding situation of the vehicle 1, by referring to map data together with data on the current position. The position data processor 12 may determine where the current position is and identify in which surrounding situation the vehicle 1 is positioned, such as on a road, in a tunnel, in a home garage, or in a parking lot. In some embodiments, the vehicle processing apparatus 15 to be described later may also determine the situation outside the vehicle 1, based on the map data and the longitude and latitude data received from the position data processor 12.

The sensors 13 may comprehensively represent various sensors provided in the vehicle 1. The sensors 13 may detect signals to be used to determine a situation inside the vehicle 1 and the situation outside the vehicle 1, and to determine whether an occupant of the vehicle 1 is in compliance with the traffic law. The sensors 13 may include sensors such as an inside-vehicle sensor 21, an outside-vehicle sensor 22, or a vehicle sensor 23.

The inside-vehicle sensor 21 may include a sensor that detects data such as presence or absence of the occupant in the vehicle 1 or a state of the occupant in the vehicle 1. In the present example embodiment, the inside-vehicle sensor 21 may include one or more cameras that each capture an image of an inside of the vehicle 1 and supply an image signal of the captured image to the vehicle processing apparatus 15. In other words, the inside-vehicle sensor 21 may include a camera serving as a so-called driver monitoring system. In some embodiments, in addition to or in place of these cameras, the inside-vehicle sensor 21 may include a sensor such as a weight sensor or a contact sensor provided in a seat. In some embodiments, the inside-vehicle sensor 21 may include a sensor, such as an infrared sensor, that detects the presence and motion of the occupant.

The inside-vehicle sensor 21 may further include sensors for various devices provided inside the vehicle 1. In the present example embodiment, the inside-vehicle sensor 21 may include sensors such as a sensor that detects an open state and a closed state of a window, a sensor that detects an open state and a closed state of a door, or a sensor that detects a fastened state and an unfastened state of a seat belt.

The outside-vehicle sensor 22 may include a sensor that detects the situation outside the vehicle 1. In the present example embodiment, the outside-vehicle sensor 22 may include one or more cameras that each capture an image of an outside of the vehicle 1 and supply an image signal of the captured image to the vehicle processing apparatus 15. In some embodiments, the one or more cameras may capture images of all areas in front and back of the vehicle 1 and on left and right of the vehicle 1, or capture an image of a muffler and its adjacent area of the engine vehicle.

In some embodiments, the outside-vehicle sensor 22 may include a vehicle height sensor that detects a vehicle height of the vehicle 1. The vehicle height sensor may be any sensor such as an ultrasonic sensor that measures a distance between the vehicle 1 and the ground. In some embodiments, the outside-vehicle sensor 22 may include a sensor such as a millimeter wave radar or a light detection and ranging (LiDAR) sensor. In some embodiments, the outside-vehicle sensor 22 may include a sensor such as an outside air temperature sensor, a humidity sensor, or an illuminance sensor.

The vehicle sensor 23 may include a sensor that detects a situation of the vehicle 1. In some embodiments, the vehicle sensor 23 may include a vehicle speed sensor that detects a speed (a vehicle speed) of the vehicle 1. In some embodiments, the vehicle sensor 23 may include a sensor such as a wheel speed sensor that detects a rotation speed of a wheel, an accelerator position sensor that detects an accelerator position in accordance with a depressed amount of an accelerator pedal, or a brake sensor that detects a brake operation amount in accordance with a depressed amount of a brake pedal. The vehicle sensor 23 may supply its detected signal to the vehicle processing apparatus 15.

As described above, the vehicle processing apparatus 15 may receive the various signals detected by the sensors 13. Note that the sensors 13 may include any other various sensors that detect a signal usable for the determination as to whether the occupant of the vehicle 1 is in compliance with the traffic law, in addition to or in place of the sensors described above.

The interface 14 may present the inside of the vehicle 1 with a notification that encourages handling in compliance with the traffic law. Non-limiting examples of this notification may include a notification indicating that the traffic law includes a revised provision, a notification indicating a content of the revised provision, and a notification that encourages the handling in compliance with the content of the revised provision (hereinafter, also referred to as a revision handling encouragement notification). In some embodiments, the interface 14 may be a display unit that displays the notification on a display such as a screen of a front console. In some embodiments, the interface 14 may be an audio outputter that issues the notification by outputting a sound such as a warning sound or an audio message.

The vehicle processing apparatus 15 includes one or more processors, and a recording medium containing a program to be executed by the one or more processors. The program includes one or more commands. The one or more commands cause the one or more processors of the vehicle processing apparatus 15 to execute processing of issuing the notification that encourages the handling in compliance with the traffic law.

In the present example embodiment, the vehicle processing apparatus 15 may cause the storage 17 to hold the current law information NW received via the communicator 11. The vehicle processing apparatus 15 may further determine whether the traffic law includes a revised provision, based on the current law information NW received via the communicator 11 and the past law information OD already held in the storage 17. If determining that the traffic law includes the revised provision, the vehicle processing apparatus 15 causes the interface 14 of the vehicle 1 to issue the notification that encourages the handling in compliance with the traffic law.

At this time, the vehicle processing apparatus 15 may further determine the situation inside the vehicle 1, the situation outside the vehicle 1, or the situation of the vehicle 1 by performing analysis processing on various signals received from devices such as the sensors 13. The vehicle processing apparatus 15 thus may issue the notification that encourages the handling in compliance with the traffic law, at a timing appropriate for each content of the revised provision.

In some embodiments, the vehicle processing apparatus 15 may also determine whether the occupant is in compliance with the traffic law, by performing the analysis processing on various signals received from devices such as the sensors 13. If determining that the occupant is not in compliance with the traffic law, the vehicle processing apparatus 15 may also perform control that restricts a start of the vehicle 1, while the vehicle 1 is in a startup state. The processing to be executed by the vehicle processing apparatus 15 will be described in detail later.

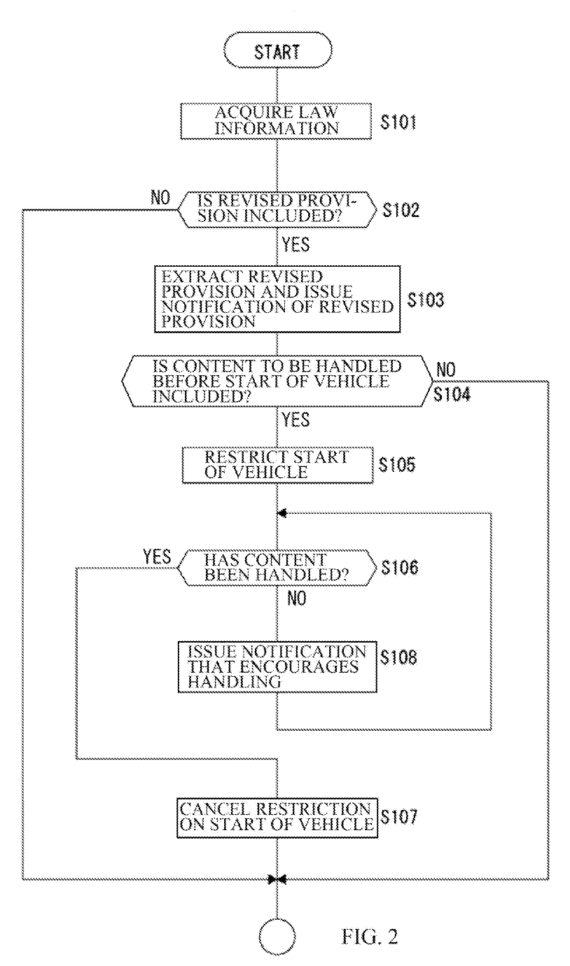

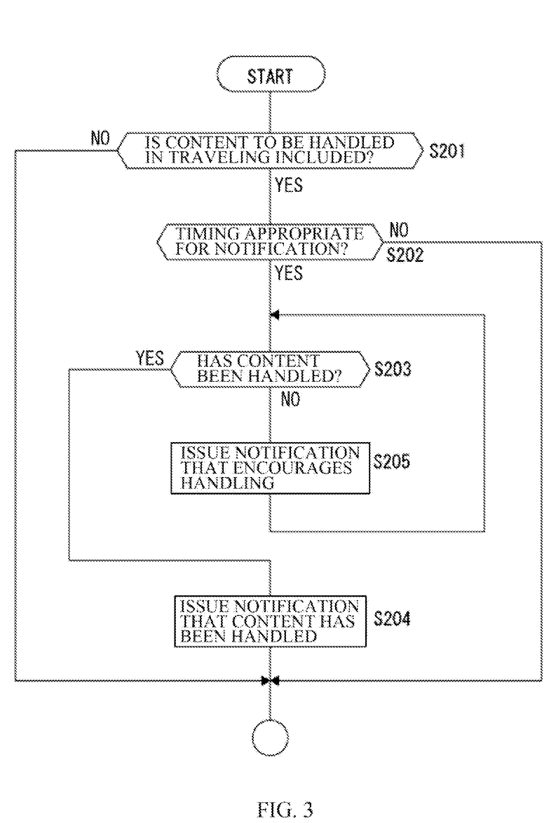

Exemplary processing to be executed by the vehicle processing apparatus 15 according to the example embodiment of the disclosure will now be described with reference to FIGS. 2 and 3. First, the vehicle processing apparatus 15 may execute processing of FIG. 2 before the start of the vehicle 1. In the present example embodiment, the vehicle processing apparatus 15 may execute the processing of FIG. 2 upon startup of the vehicle 1. The vehicle 1 may be started up when an ignition switch is switched from an off state to an on state in response to an operation performed by a person such as a driver who drives the vehicle 1.

The vehicle processing apparatus 15 may acquire the current law information NW from the law management institution via the communicator 11 (step S101). The vehicle processing apparatus 15 may further acquire the past law information OD from the storage 17. In the present example embodiment, the vehicle processing apparatus 15 may acquire, as the past law information OD, the most recent law information before the current law information NW. The past law information OD may be the law information acquired from the law management institution and stored in the storage 17 in the previous execution of the processing of FIG. 2 by the vehicle processing apparatus 15.

The vehicle processing apparatus 15 may cause the storage 17 to hold the current law information NW. The current law information NW held in this operation may be usable as the past law information OD in the next processing to be executed upon the next startup of the vehicle 1.

Thereafter, the vehicle processing apparatus 15 determines whether the current law information NW includes a revised provision provided by revision made to the past law information OD (step S102). In the present example embodiment, the vehicle processing apparatus 15 may determine a difference between the current law information NW and the past law information OD as the revised provision by performing the analysis processing on the current law information NW and the past law information OD.

In some embodiments, the current law information NW received from the law management institution may be linked in advance with data indicating whether the current law information NW includes the revised provision. In such embodiments, the vehicle processing apparatus 15 may determine whether the current law information NW includes the revised provision, based on the data linked with the current law information NW.

If determining that the current law information NW includes no revised provision (step S102: NO), the vehicle processing apparatus 15 may end the processing of FIG. 2. If determining that the current law information NW includes the revised provision (step S102: YES), the vehicle processing apparatus 15 may cause the processing to proceed from step S102 to step S103, and extract one or more contents of the revised provision by performing the analysis processing on the difference in the current law information NW (step S103).

The one or more contents of the revised provision may be related to a rule changed or added by revision of the traffic law, and include a content of the rule necessitating the occupant of the vehicle 1 performing the handling in compliance with the rule. In the present example embodiment, the one or more contents of the revised provision may be related to a content such as a position or a motion of the occupant inside the vehicle 1, an article to be brought into or fixed inside the vehicle 1, a specification of the vehicle 1, or a driving operation of the vehicle 1. Non-limiting examples of the one or more contents of the revised provision may include various contents such as "mandatory fastening of the seat belt of the occupant in a back seat", "mandatory use of a child safety seat for an infant occupant", a "change in vehicle height limits", or a "change in speed limits in a predetermined travel zone".

In some embodiments, the vehicle processing apparatus 15 may extract the one or more contents of the revised provision, based on machine learning by an artificial intelligence (AI) engine. The vehicle processing apparatus 15 may perform the machine learning by accumulating data such as the content of the revised provision to be generated in accordance with the difference in the law information. Such machine learning may allow the vehicle processing apparatus 15 to generate the one or more contents of the revised provision, based on the difference in the law information resulting from the analysis processing.

In some embodiments, the storage 17 may hold in advance the one or more contents of the revised provision in such a manner that the one or more contents of the revised provision are linked with the difference in the law information resulting from the analysis processing. In such embodiments, the vehicle processing apparatus 15 may acquire the one or more contents of the revised provision corresponding to the difference in the law information resulting from the analysis processing, by referring to the storage 17.

In some embodiments, the one or more contents of the revised provision may be linked in advance with the current law information NW received from the law management institution. In such embodiments, the vehicle processing apparatus 15 may acquire the one or more contents of the revised provision, based on data linked with the current law information NW.

The vehicle processing apparatus 15 may set each extracted content of the revised provision as necessitating the revision handling encouragement notification. In the present example embodiment, the vehicle processing apparatus 15 may link each content of the revised provision with a flag (hereinafter, also referred to as a notification flag), and set the notification flag to an on state. The vehicle processing apparatus 15 may determine that a content of the revised provision of which the notification flag is in the on state necessitates the revision handling encouragement notification. In this example, the storage 17 may hold a setting state of the notification flag of each content of the revised provision.

Thereafter, the vehicle processing apparatus 15 may issue a notification indicating that the traffic law includes the revised provision and indicating the one or more contents of the revised provision by causing the interface 14 to present the notification (step S103). In some embodiments, the vehicle processing apparatus 15 may cause an in-vehicle component such as a display inside the vehicle 1 to display the notification. In some embodiments, the vehicle processing apparatus 15 may issue the notification by outputting a sound from a speaker provided inside the vehicle 1.

Thereafter, the vehicle processing apparatus 15 may determine whether the one or more contents of the revised provision include a content of the revised provision to be handled before the start of the vehicle 1 (step S104). The content of the revised provision to be handled before the start of the vehicle 1 may include a content such as a content necessary for the vehicle 1 to start and travel safely, or a content handleable in traveling of the vehicle 1 but recommended to be handled before the start of the vehicle 1. Non-limiting examples of the content of the revised provision to be handled before the start of the vehicle 1 may include contents such as the "mandatory fastening of the seat belt of the occupant in the back seat", the "mandatory use of the child safety seat for an infant occupant", or the "change in vehicle height limits".

In some embodiments, the storage 17 may hold each content of the revised provision in such a manner that the relevant content of the revised provision is linked with a timing when the relevant content of the revised provision is to be handled. In such embodiments, the vehicle processing apparatus 15 may determine whether the one or more contents of the revised provision include the content of the revised provision to be handled before the start of the vehicle 1, by referring to the storage 17.

In some embodiments, the vehicle processing apparatus 15 may also determine whether the one or more contents of the revised provision include the content of the revised provision to be handled before the start of the vehicle 1, based on the machine learning by the AI engine. The vehicle processing apparatus 15 may perform the machine learning by accumulating data such as the timing when each content of the revised provision of the law information is to be handled. Such machine learning may allow the vehicle processing apparatus 15 to determine whether the one or more contents of the revised provision include the content of the revised provision to be handled before the start of the vehicle 1.

In some embodiments, the law information received from the law management institution may be linked in advance with the timing when each content of the revised provision is to be handled. In such embodiments, the vehicle processing apparatus 15 may determine whether the one or more contents of the revised provision include the content of the revised provision to be handled before the start of the vehicle 1, based on data linked with the acquired current law information NW.

The vehicle processing apparatus 15 may extract a content necessitating the revision handling encouragement notification from the one or more contents of the revised provision, and determine whether each extracted content of the revised provision is to be handled before the start of the vehicle 1. In the present example embodiment, the vehicle processing apparatus 15 may extract the content of the revised provision of which the notification flag is in the on state as necessitating the revision handling encouragement notification, by referring to the storage 17.

If determining that the one or more contents of the revised provision include no content of the revised provision to be handled before the start of the vehicle 1 (step S104: NO), the vehicle processing apparatus 15 may end the processing of FIG. 2. If determining that the one or more contents of the revised provision include the content of the revised provision to be handled before the start of the vehicle 1 (step S104: YES), the vehicle processing apparatus 15 may cause the processing to proceed from step S104 to step S105.

The vehicle processing apparatus 15 may execute control that restricts the start of the vehicle 1 (step S105). In some embodiments, the vehicle processing apparatus 15 may restrict the start of the vehicle 1 by a method such as limiting an operation of a shift lever. In some embodiments, the vehicle processing apparatus 15 may also restrict the start of the vehicle 1 by controlling a transmission mechanism to block transmission of power to drive wheels. In this way, the start of the vehicle 1 may be restricted when the occupant has not handled the content of the revised provision to be handled before the start of the vehicle 1.

Thereafter, the vehicle processing apparatus 15 may determine whether the content of the revised provision to be handled by the occupant before the start of the vehicle 1 has been handled (step S106). In the present example embodiment, the vehicle processing apparatus 15 may determine whether the content of the revised provision to be handled by the occupant before the start of the vehicle 1 has been handled, based on signals received from the sensors 13. In some embodiments, the vehicle processing apparatus 15 may also determine whether the content of the revised provision to be handled before the start of the vehicle 1 has been handled, based on data received via the communicator 11 and data acquired from the position data processor 12.

In one example where the content of the revised provision is related to the "mandatory fastening of the seat belt of the occupant in the back seat", the vehicle processing apparatus 15 may determine whether the occupant has fastened the seat belt, based on a detection signal received from the sensor that is included in the inside-vehicle sensor 21 and detects the fastened state and the unfastened state of the seat belt.

In another example where the content of the revised provision is related to the "mandatory use of the child safety seat for an infant occupant", the vehicle processing apparatus 15 may determine whether the infant is seated in the child safety seat in the vehicle 1 and whether the child safety seat is disposed at an appropriate position in the vehicle 1, by performing image analysis processing on an image signal of a captured image of the inside of the vehicle 1 received from the camera included in the inside-vehicle sensor 21.

In still another example where the content of the revised provision is related to the "change in vehicle height limits", the vehicle processing apparatus 15 may determine whether the vehicle height of the vehicle 1 is within the range of the vehicle height limits, based on a detection signal received from the vehicle height sensor included in the outside-vehicle sensor 22.

If determining that the content of the revised provision to be handled by the occupant before the start of the vehicle 1 has not been handled (step S106: NO), the vehicle processing apparatus 15 may cause the processing to proceed to step S108, and cause the interface 14 to present the revision handling encouragement notification (step S108). The interface 14 may present the notification including a message such as "Fasten your seat belt", "Settle the infant into the child safety seat", or "The vehicle height exceeds the limit".

Thereafter, the vehicle processing apparatus 15 may cause the interface 14 to present the revision handling encouragement notification in step S108 until determining that the content of the revised provision to be handled before the start of the vehicle 1 has been handled in step S106.

If determining that the content of the revised provision to be handled before the start of the vehicle 1 has been handled (step S106: YES), the vehicle processing apparatus 15 may cause the processing to proceed to step S107, and cancel the control that restricts the start of the vehicle 1 (step S107). The vehicle processing apparatus 15 may further cause the interface 14 to present the notification indicating the content of the revised provision to be handled before the start of the vehicle 1 has been handled. Upon handling the content demanded by the revised provision, the driver of the vehicle 1 may be allowed to start the vehicle 1.

At this time, the vehicle processing apparatus 15 may further cancel the setting of the handled content of the revised provision as necessitating the revision handling encouragement notification. In the present example embodiment, the vehicle processing apparatus 15 may set the notification flag of the content of the revised provision determined to have been handled to an off state. Such a setting cancellation may cause the revision handling encouragement notification to be unissued in and after step S107. In some embodiments, the vehicle processing apparatus 15 may also set the revision handling encouragement notification to be issued a plurality of times by defining a condition for setting the notification flag to the off state as issuance of the revision handling encouragement notification a plurality of times. After the process of step S107, the vehicle processing apparatus 15 may end the processing illustrated in FIG. 2.

Thereafter, the vehicle processing apparatus 15 may execute processing of FIG. 3 after the start of the vehicle 1. In other words, the vehicle processing apparatus 15 may execute the processing of FIG. 3 in traveling of the vehicle 1.

The vehicle processing apparatus 15 may determine whether the one or more contents of the revised provision include a content of the revised provision to be handled in traveling of the vehicle 1 (step S201). The content of the revised provision to be handled in traveling of the vehicle 1 may include a content necessary for the vehicle 1 to travel safely, such as the "change in speed limits in the predetermined travel zone".

The vehicle processing apparatus 15 may extract a content necessitating the revision handling encouragement notification from the one or more contents of the revised provision, and determine whether each extracted content of the revised provision is to be handled in traveling of the vehicle 1. In the present example embodiment, the vehicle processing apparatus 15 may extract a content of the revised provision of which the notification flag is in the on state as necessitating the revision handling encouragement notification, by referring to the storage 17.

In some embodiments, the vehicle processing apparatus 15 may also determine whether the one or more contents of the revised provision include the content of the revised provision to be handled in traveling of the vehicle 1, based on the machine learning by the AI engine. In some embodiments where the law information received from the law management institution is linked in advance with the timing when each content of the revised provision is to be handled, the vehicle processing apparatus 15 may determine whether the one or more contents of the revised provision include the content of the revised provision to be handled in traveling of the vehicle 1, based on data linked with the acquired current law information NW.

If determining that the one or more contents of the revised provision include no content of the revised provision to be handled in traveling of the vehicle 1 (step S201: NO), the vehicle processing apparatus 15 may end the processing of FIG. 3. If determining that the one or more contents of the revised provision include the content of the revised provision to be handled in traveling of the vehicle 1 (step S201: YES), the vehicle processing apparatus 15 may cause the processing to proceed from step S201 to step S202.

The vehicle processing apparatus 15 may determine whether the content of the revised provision to be handled in traveling of the vehicle 1 include a content necessitating the revision handling encouragement notification (step S202). In other words, the vehicle processing apparatus 15 may determine whether the revision handling encouragement notification is to be issued at a current timing.

At this time, the vehicle processing apparatus 15 may determine the timing of issuing the notification, based on signals received from the sensors 13. In some embodiments, the vehicle processing apparatus 15 may also determine whether the content of the revised provision to be handled in traveling of the vehicle 1 has been handled, based on data received via the communicator 11 and data acquired from the position data processor 12.

In yet another example where the content of the revised provision is related to the "change in speed limits in the predetermined travel zone", the vehicle processing apparatus 15 may determine whether the vehicle 1 is traveling in the predetermined travel zone and whether the vehicle 1 is approaching the predetermined travel zone, by performing the image analysis processing on position data acquired from the position data processor 12 and an image signal of a captured image of the outside of the vehicle 1 received from the camera included in the inside-vehicle sensor 21.

In some embodiments, the vehicle processing apparatus 15 may determine whether the vehicle speed of the vehicle 1 is within the range of the speed limits, based on a signal such as a detection signal received from the vehicle speed sensor included in the vehicle sensor 23.

In such embodiments, if determining that the vehicle 1 is positioned in the predetermined travel zone and the vehicle speed is outside the range of the speed limits, the vehicle processing apparatus 15 may determine that the revision handling encouragement notification is to be issued at the current timing. In some embodiments, if determining that the vehicle 1 is approaching the predetermined travel zone, the vehicle processing apparatus 15 may determine that the revision handling encouragement notification is to be issued at the current timing.

Thereafter, the vehicle processing apparatus 15 may determine whether the content of the revised provision to be handled by the occupant in traveling of the vehicle 1 has been handled (step S203). In the present example embodiment, the vehicle processing apparatus 15 may determine whether the content of the revised provision to be handled by the occupant in traveling of the vehicle 1 has been handled, based on signals received from the sensors 13. In some embodiments, the vehicle processing apparatus 15 may also determine whether the content of the revised provision to be handled in traveling of the vehicle 1 has been handled, based on the data received via the communicator 11 and the data acquired from the position data processor 12.

In the example where the content of the revised provision is related to the "change in speed limits in the predetermined travel zone", the vehicle processing apparatus 15 may determine whether the vehicle speed is within the range of the speed limits, based on the detection signal received from the vehicle speed sensor included in the vehicle sensor 23. The vehicle processing apparatus 15 may determine whether the vehicle 1 is positioned in the predetermined travel zone, based on the position data on the vehicle 1 acquired from the position data processor 12.

In some embodiments, if the vehicle speed is within the range of the speed limits, the vehicle processing apparatus 15 may determine that the content of the revised provision to be handled by the occupant in traveling of the vehicle 1 has been handled. In some embodiments, if the vehicle 1 is positioned outside the predetermined travel zone, the vehicle processing apparatus 15 may determine that the content of the revised provision to be handled by the occupant in traveling of the vehicle 1 has been handled. In some embodiments, if the vehicle 1 is positioned in the predetermined travel zone and the vehicle speed is outside the range of the speed limits, the vehicle processing apparatus 15 may determine that the content of the revised provision to be handled by the occupant in traveling of the vehicle 1 has not been handled.

If determining that the content of the revised provision to be handled by the occupant in traveling of the vehicle 1 has not been handled (step S203: NO), the vehicle processing apparatus 15 may cause the processing to proceed to step S205, and cause the interface 14 to present the revision handling encouragement notification (step S205). The interface 14 may present the notification such as "The vehicle speed is outside the range of the speed limits in the travel zone".

Thereafter, the vehicle processing apparatus 15 may cause the interface 14 to present the revision handling encouragement notification in step S205 until determining that the content of the revised provision to be handled in traveling of the vehicle 1 has been handled in step S203.

If determining that the content of the revised provision to be handled in traveling of the vehicle 1 has been handled (step S203: YES), the vehicle processing apparatus 15 may cause the processing to proceed to step S204, and cause the interface 14 to present the notification indicating that the content of the revised provision to be handled in traveling of the vehicle 1 has been handled (step S204). This may allow the occupant of the vehicle 1 to confirm that the content demanded by the revised provision has been handled.

At this time, the vehicle processing apparatus 15 may further cancel the setting of the handled content of the revised provision as necessitating the revision handling encouragement notification. In the present example embodiment, the vehicle processing apparatus 15 may set the notification flag of the content of the revised provision determined to have been handled to the off state. Such a setting cancellation may cause the revision handling encouragement notification to be unissued in and after step S204. In some embodiments, the vehicle processing apparatus 15 may also set the revision handling encouragement notification to be issued a plurality of times by defining a condition for setting the notification flag to the off state as issuance of the revision handling encouragement notification a plurality of times. After the process of step S204, the vehicle processing apparatus 15 may end the processing illustrated in FIG. 3.

According to the present example embodiment of the disclosure described above, the vehicle processing apparatus 15 acquires the current law information NW as the law information. The vehicle processing apparatus 15 further determines whether the acquired current law information NW includes the revised provision provided by the revision made to the past law information OD. The past law information OD is held in the storage 17 of the vehicle 1. The vehicle processing apparatus 15 further causes, when determining that the current law information NW includes the revised provision, the interface 14 of the vehicle 1 to present the revision handling encouragement notification, as illustrated in FIGS. 2 and 3.

Such a configuration helps to allow the occupant of the vehicle 1 to confirm what to handle to comply with a change made by, for example, the revision of the traffic law or the revised provision of the traffic law. This helps to prevent the occupant of the vehicle 1 from unintentionally violating the traffic law due to failing to grasp the revised provision.

In some embodiments, the vehicle processing apparatus 15 may further cause, when determining that the current law information NW includes the revised provision, the interface 14 to present the revision handling encouragement notification at a timing corresponding to the content of the revised provision, as illustrated in steps S102 to S108 of FIG. 2 and steps S201 to S205 of FIG. 3, for example.

Such a configuration helps to present the revision handling encouragement notification to the occupant at an appropriate timing. Such a presentation helps to allow the occupant to recognize the handling in compliance with the revised provision in a necessary situation. This helps to prevent the occupant from forgetting to handle the content of the revised provision after the time has elapsed since the issuance of the notification, and further encourages the occupant to comply with the traffic law.

In some embodiments, the vehicle processing apparatus 15 may acquire, upon the startup of the vehicle 1, the current law information NW. The vehicle processing apparatus 15 may further cause, when the revised provision includes the content to be handled before the start of the vehicle 1, the interface 14 to present the revision handling encouragement notification at a timing before the start of the vehicle 1, as illustrated in steps S102 to S108 of FIG. 2, for example.

Such a configuration helps to allow the occupant of the vehicle 1 to confirm what to handle to comply with the change made by, for example, the revision of the traffic law or the revised provision of the traffic law, before the start of the vehicle 1. The configuration allowing the occupant to perform the handling in compliance with the revised provision before the start of the vehicle 1 thus encourages the occupant to comply with the traffic law, securing safety of the occupant after the start of the vehicle 1.

In some embodiments, the vehicle processing apparatus 15 may impose, when the revised provision includes the content to be handed before the start of the vehicle 1, a restriction on the start of the vehicle 1. The vehicle processing apparatus 15 may further determine whether the content demanded by the revised provision to be handled before the start of the vehicle 1 has been handled. The vehicle processing apparatus 15 may cancel, when determining that the content demanded by the revised provision to be handled before the start of the vehicle 1 has been handled, the restriction on the start of the vehicle 1, as illustrated in steps S105 to S107 of FIG. 2, for example.

Such a configuration restricts the start of the vehicle 1 until the occupant has handled the content demanded by the revised provision. Such a restriction even on the vehicle 1 itself exerts a compelling force on the occupant, and further encourages the occupant to comply with the traffic law before the start of the vehicle 1.

In some embodiments, the vehicle processing apparatus 15 may cause, when the revised provision includes the content to be handled in traveling of the vehicle 1, the interface 14 to present the revision handling encouragement notification at a timing corresponding to the surrounding situation of the vehicle 1, as illustrated in steps S201 and S202 of FIG. 3, for example.

Such a configuration helps to allow the occupant to recognize the handling in compliance with the revised provision at the timing appropriate for the surrounding situation of the vehicle 1. This helps to prevent the occupant from forgetting to handle the content of the revised provision after the time has elapsed since the issuance of the notification, and further encourages the occupant to comply with the traffic law.

According to at least one embodiment of the disclosure, it is possible to prevent an occupant of a vehicle from unintentionally violating a traffic law.

The example effects described herein are merely examples and non-limiting. Any other effect or a part of the effects described herein may be achieved by any embodiment of the disclosure. Further, the example embodiment described herein is merely an example, and all of combinations of the configurations described in the foregoing example embodiment may not necessarily be essential to solve an object of any embodiment of the disclosure.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms "a", "an", and "the" include, especially in the context of the claims, are to be construed to cover both the singular and the plural, unless otherwise indicated herein or clearly contradicted by context.

Throughout this specification and the appended claims, unless the context requires otherwise, the terms "comprise", "include", "have", and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term "substantially", "approximately", "about", and its variants having a similar meaning thereto are defined as being largely but not necessarily wholly what is specified as understood by one of ordinary skill in the art.

The term "disposed on/ provided on/ formed on" and its variants having a similar meaning thereto as used herein refer to elements disposed directly in contact with each other or indirectly by having intervening structures therebetween.

The vehicle processing apparatus 15 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the vehicle processing apparatus 15. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the vehicle processing apparatus 15 illustrated in FIG. 1.

1. A vehicle processing apparatus configured to be applied to a vehicle, the vehicle processing apparatus comprising:
one or more processors; and
a non-transitory computer readable recording medium containing a program configured to be executed by the one or more processors, wherein
the program comprises one or more commands, and
the one or more commands are configured to cause the one or more processors to
acquire current law information as road traffic-related law information,
determine whether the current law information comprises a revised provision provided by revision made to past law information, the past law information being held in a storage of the vehicle, and
cause, when determining that the current law information comprises the revised provision, an interface of the vehicle to present a notification that encourages handling in compliance with the revised provision.

2. The vehicle processing apparatus according to claim 1, wherein the one or more commands are configured to cause the one or more processors to cause, when determining that the current law information comprises the revised provision, the interface to present the notification at a timing corresponding to a content of the revised provision.

3. The vehicle processing apparatus according to claim 2, wherein the one or more commands are configured to cause the one or more processors to
acquire, upon startup of the vehicle, the current law information, and
cause, when the revised provision comprises a content to be handled before a start of the vehicle, the interface to present the notification at a timing before the start of the vehicle.

4. The vehicle processing apparatus according to claim 3, wherein the one or more commands are configured to cause the one or more processors to
impose, when the revised provision comprises the content to be handled before the start of the vehicle, a restriction on the start of the vehicle,
determine whether the content demanded by the revised provision to be handled before the start of the vehicle has been handled, and cancel, when determining that the content demanded by the revised provision to be handled before the start of the vehicle has been handled, the restriction on the start of the vehicle.

5. The vehicle processing apparatus according to claim 2, wherein the one or more commands are configured to cause the one or more processors to cause, when the revised provision comprises a content to be handled in traveling of the vehicle, the interface to present the notification at a timing corresponding to a surrounding situation of the vehicle.
